(19) United States
(12) Patent Application Publication
(10) Pub. No.: US 2015/0074524 A1
(43) Pub. Date: Mar. 12, 2015

(54) MANAGEMENT OF VIRTUAL ASSISTANT ACTION ITEMS

(71) Applicant: Lenovo (Singapore) Pte. Ltd., Singapore (SG)

(72) Inventors: John Weldon Nicholson, Cary, NC (US); Steven Richard Perrin, Raleigh, NC (US); Song Wang, Cary, NC (US); John Miles Hunt, Raleigh, NC (US); Jianbang Zhang, Raleigh, NC (US); Jian Li, Chapel Hill, NC (US); Toby John Bowen, Durham, NC (US)

(21) Appl. No.: 14/022,876

(22) Filed: Sep. 10, 2013

(51) Int. Cl. G06F 3/16; G06F 3/0484; G06F 9/44

(52) U.S. Cl. CPC G06F 3/167; G06F 9/4446; G06F 3/04842
USPC 715/706

(57) ABSTRACT

An aspect provides a method, including: operating an audio receiver and a memory of an information handling device to store audio; receiving input activating a virtual assistant of the information handling device; and after activation of the virtual assistant, processing the audio stored to identify one or more actionable items for the virtual assistant. Other aspects are described and claimed.

### BACKGROUND

Information handling devices (“devices”), for example laptop and desktop computers, smart phones, e-readers, etc., are often used in a context where virtual assistant is available. An example of a virtual assistant is the SIRI application. SIRI is a registered trademark of Apple Inc. in the United States and/or other countries.

A virtual assistant may perform many functions for a user, e.g., executing search queries in response to voice commands. Users often “wake” the virtual assistant by way of an input, e.g., audibly saying the virtual assistant's “name”. Thus, a virtual assistant is activated by a user and thereafter may respond to queries presented by the user.

### BRIEF SUMMARY

In summary, one aspect provides a method, comprising: operating an audio receiver and a memory of an information handling device to store audio; receiving input activating a virtual assistant of the information handling device; and after activation of the virtual assistant, processing the audio stored to identify one or more actionable items for the virtual assistant.

Another aspect provides an information handling device, comprising: an audio receiver; one or more processors; and a memory device accessible to the one or more processors and storing code executable by the one or more processors to: operate the audio receiver and a memory to store audio; receive input activating a virtual assistant of the information handling device; and after activation of the virtual assistant, process the audio stored to identify one or more actionable items for the virtual assistant.

A further aspect provides a program product, comprising: a storage device having computer readable program code stored therewith, the computer readable program code comprising: computer readable program code configured to operate an audio receiver and a memory of an information handling device to store audio; computer readable program code configured to receive input activating a virtual assistant of the information handling device; and computer readable program code configured to, after activation of the virtual assistant, process the audio stored to identify one or more actionable items for the virtual assistant.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for management of virtual assistant action items.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

One of the current problems with virtual assistants (VA) is that they cannot be “always on” due to power consumption limits. So when a query or command for the VA happens in conversation with others, the query or command (“action item”) needs to be restated to the VA after waking the VA up, e.g., by stating the VA's name or providing another activating input. In other words, currently virtual assistants are not “always on” but rather are activated, at which point (i.e., thereafter) a query or command may be issued to the VA for processing and execution of a related action.

Accordingly, an embodiment implements a buffering mechanism for an audio receiver, e.g., an on-board microphone. A predetermined amount of audio is stored, e.g., the last “x” seconds of audio data, such that a running buffer of audio data is continuously available. For example, the buffer or memory storing the audio data may be thought of as a running or circular buffer. Thus, when the VA is activated or triggered, it can process the buffer contents looking for action items (e.g., audio data previously associated or keyed to queries or commands). In an embodiment, the mechanism may be read from (e.g., by the application processor after waking up the VA) and written to (e.g., as the microphone collected audio data continues to come in) at the same time.

The illustrated example embodiments will be best understood by reference to the figures. The following description is intended only by way of example, and simply illustrates certain example embodiments.

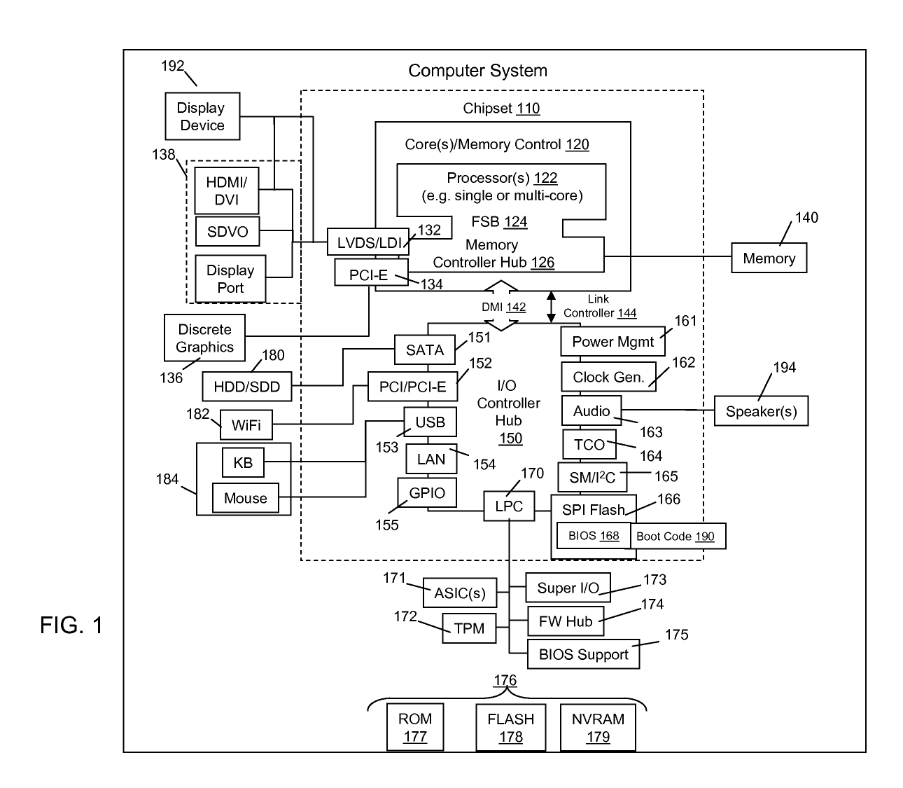

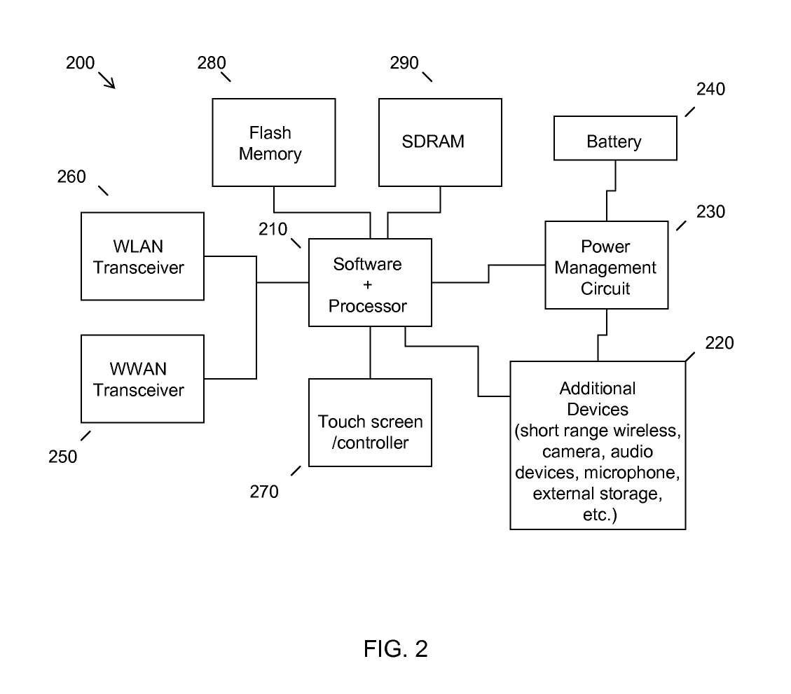

Referring to FIG. 1 and FIG. 2, while various other circuits, circuitry or components may be utilized in information handling devices, with regard to smart phone and/or tablet circuitry 200, an example illustrated in FIG. 2 includes a system on a chip design found for example in tablet or other mobile computing platforms. Software and processor(s) are combined in a single chip 210. Internal busses and the like depend on different vendors, but essentially all the peripheral devices (220) such as a microphone may attach to a single chip 210. In contrast to the circuitry illustrated in FIG. 1, the circuitry 200 combines the processor, memory control, and I/O controller hub all into a single chip 210. Also, systems 200 of this type do not typically use SATA or PCI or LPC. Common interfaces for example include SDIO and I2C.

There are power management chip(s) 230, e.g., a battery management unit, BMU, which manage power as supplied for example via a rechargeable battery 240, which may be recharged by a connection to a power source (not shown). In at least one design, a single chip, such as 210, is used to supply BIOS like functionality and DRAM memory.

System 200 typically includes one or more of a WWAN transceiver 250 and a WLAN transceiver 260 for connecting to various networks, such as telecommunications networks and wireless base stations. Commonly, system 200 will include a touch screen 270 for data input and display. System 200 also typically includes various memory devices, for example flash memory 280 and SDRAM 290.

FIG. 1, for its part, depicts a block diagram of another example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling devices, as for example outlined in FIG. 1 and FIG. 2, may be used in connection with a VA. The devices may accept input, e.g., audio input, to both activate the VA and to collect input regarding actions to be executed. According to an embodiment, such devices may also include a memory or buffer location allocated to collect audio either continuously or via an appropriate intelligent trigger (e.g., activation of an audio receiver and storage of audio data responsive to detecting a threshold level of ambient audio).

As described herein, an embodiment implements a buffering mechanism to collect a predetermined amount of audio, where the amount of predetermined audio stored may be modified, e.g., according to various factor(s). Thus, rather than having to repeat audio that contained an action item (e.g., a query or command) spoken prior to activating the VA, according to an embodiment when the VA is activated or triggered, it can process the buffer contents looking for action items (e.g., audio data previously associated or keyed to queries or commands). This avoids unnecessary repetition of commands and queries to the VA.

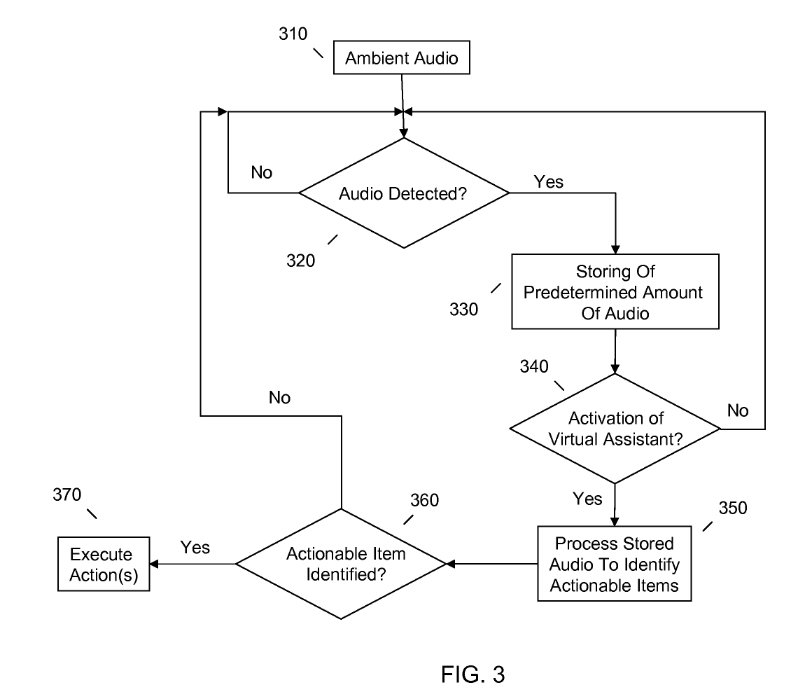

In FIG. 3 an example method of management of virtual assistant action items is illustrated. An embodiment monitors the ambient audio 310 in the environment that, if detected at 320, may be stored 330, e.g., in a memory location. The ambient audio may be continually monitored and stored (e.g., omitting step 320); however, power savings may be had if a predetermined level of ambient audio is used to trigger a detection of ambient audio at 320 and beginning of storage at 330.

Thus, the buffering mechanism may operate in a low power or always on mode or a threshold may be implemented at 320 to only record into the buffer when there is detectable microphone activity; that is, to not waste power recording silence. Examples of techniques that may accomplish this are instantaneous power or crest factor threshold detection. Because the contents of the buffer may be fragmented in time (e.g., with periods of silence between periods of activity/recording), the contents may be time-stamped or otherwise processed to ensure appropriate management of the buffer contents.

In an embodiment, the predetermined amount of audio stored at 330 may be varied according to various factor(s). For example, the length of the buffer may vary dynamically by the context encountered. Thus, if a particularly lengthy discussion is taking place, the buffer may be made longer automatically to capture additional audio. Also, the length of the buffer may be reduced according to various factor(s). Some reasons for not using the full memory capacity of the buffer all the time or reducing the size of the buffer would be: power consumption, processing delay after triggering, and privacy concerns, etc.

As part of the monitoring of the ambient audio to detect audio at 320, a determination may be made as to whether a VA has been activated at 340. The VA may be activated in a variety of ways, for example via use of audio input data, e.g., speaking the VA's “name” or other predetermined word or phrase. Additionally, an embodiment may use other detected input, e.g., a discreet gesture or tapping pattern, as a VA activation trigger sensed at 340. For example, instead of talking to his or her VA, a user could give a signal to activate the VA and/or to process the audio buffer at 350 with a tap gesture while the device, e.g., phone, was still in the user's pocket. Notably, the user may activate the VA with or without processing stored audio.

In addition to always processing the stored audio on VA activation, an embodiment may selectively process the stored audio on VA activation. For example, an embodiment may utilize as part of the triggering analysis for processing of the buffer contents use of a unique symbol, e.g., a handwritten symbol sensed by a touch sensitive surface. For example, drawing a star symbol, a common note-taking symbol to indicate a key point, may trigger the buffer to be transcribed. Further actions, as described herein, may automatically flow from this, such as saving the stored audio as transcribed text as an action executed at 370. For example, this might be done in a meeting as a supplement to the user's own notes.

In an embodiment, the trigger mechanism of 340 for activating the VA and processing the stored audio in the buffer (to identify actionable items at 350) may include the use of key word(s) or phrase(s) associated with VA activation and or indications to search the stored audio content. For example, use of pronouns like “that” may be pre-associated with or keyed to an action of searching the buffer contents for actionable items. For example, if the following audio received: User A: “User B, will you pick up some milk on the way home today?”; User B: “Smartphone, remind me about that”, an embodiment may perform the following.

Upon VA wake-up at 340 by the “Smartphone” keyword, the command to “remind me about that” tells the VA to process the microphone buffer looking for candidates for actionable items, in this case a reminder, e.g., a candidate for a calendar entry, containing words or phrases indicative of who (“you”), what (“pick up milk”), when (“on the way home today”), and/or where. Thus, an embodiment may utilize initial commands received by a VA to help identify actionable items stored in buffered audio and thereafter executing actions at 370 based on the actionable items identified at 360. Similarly, other actions may be executed at 370. Some non-limiting examples include transferring the raw audio data to another location, transcribing the audio into text and transferring the transcribed text to another application, e.g., a calendar entry, and initiating higher-level processing, e.g., speech analysis, speaker identification, etc. of stored audio and correlation with device contacts, etc.

Therefore, an embodiment may ascertain a trigger or symbol waking or activating the VA at 340 and process the stored audio to identify actionable items automatically at 350. After identifying actionable item(s) at 360, an embodiment may take or execute additional actions at 370, e.g., automatically preparing a calendar entry, adding a reminder to a to-do list, executing a search based on a query identified in the stored audio, etc.

By storing audio content on a rolling basis, noting that the amount of predetermined audio may be modified (either dynamically, automatically, or via user input), an embodiment will have buffered audio contents that may be leveraged in a backward-looking analysis to identify VA commands, queries, etc. This reduces the need to re-state actionable items, e.g., commands, to the VA post-activation. Thus, a user is free to continue discussions, tasks, etc., without re-stating such commands, queries, etc.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
operating an audio receiver and a memory of an information handling device to store audio;
receiving input activating a virtual assistant of the information handling device; and
after activation of the virtual assistant, processing the audio stored to identify one or more actionable items for the virtual assistant.

2. The method of claim 1, further comprising:
identifying, in the input activating the virtual assistant, one or more key inputs; and
utilizing the one or more key inputs as a trigger for processing the audio stored to identify the one or more actionable items for the virtual assistant.

3. The method of claim 2, wherein the one or more key inputs are selected from the group of inputs consisting of a key word, a key phrase, a gesture, and a touch input.

4. The method of claim 3, wherein the one or more key inputs are keyed to an indication that the audio stored contains actionable items.

5. The method of claim 1, wherein the one or more actionable items are selected from the group of actionable items consisting of a query, a command and a reminder.

6. The method of claim 5, further comprising, after identifying one or more actionable items from the audio stored, executing one or more actions via the virtual assistant.

7. The method of claim 1, wherein the input activating the virtual assistant is selected from the group of inputs consisting of an audio input, a gesture input, and a predetermined symbol input;
said method further comprising, after detecting the input activating the virtual assistant, executing one or more actions via the virtual assistant.

8. The method of claim 1, wherein the predetermined amount of audio is variable according to one or more factors.

9. The method of claim 8, wherein the one or more factors include a determination that an initial allocation of memory is insufficient for storing ongoing audio input.

10. The method of claim 8, wherein the one or more factors are selected from the group of factors consisting of power consumption, processing delay, and privacy.

11. An information handling device, comprising:
an audio receiver;
one or more processors; and
a memory device accessible to the one or more processors and storing code executable by the one or more processors to:
operate the audio receiver and a memory to store audio;
receive input activating a virtual assistant of the information handling device; and
after activation of the virtual assistant, process the audio stored to identify one or more actionable items for the virtual assistant.

12. The information handling device of claim 1, wherein the code is executable by the one or more processors to:
identify, in the input activating the virtual assistant, one or more key inputs; and
utilize the one or more key inputs as a trigger for processing the audio stored to identify the one or more actionable items for the virtual assistant.

13. The information handling device of claim 12, wherein the one or more key inputs are selected from the group of inputs consisting of a key word, a key phrase, a gesture, and a touch input.

14. The information handling device of claim 13, wherein the one or more key inputs are keyed to an indication that the audio stored contains actionable items.

15. The information handling device of claim 11, wherein the one or more actionable items are selected from the group of actionable items consisting of a query, a command and a reminder.

16. The information handling device of claim 15, wherein the code is executable by the one or more processors to, after identifying one or more actionable items from the audio stored, execute one or more actions via the virtual assistant.

17. The information handling device of claim 11, wherein the input activating the virtual assistant is selected from the group of inputs consisting of an audio input, a gesture input, and a predetermined symbol input;
wherein the code is executable by the one or more processors to, after detecting the input activating the virtual assistant, execute one or more actions via the virtual assistant.

18. The information handling device of claim 11, wherein the predetermined amount of audio is variable according to one or more factors.

19. The information handling device of claim 18, wherein the one or more factors are selected from the group of factors consisting of power consumption, processing delay, and privacy.

20. A program product, comprising:
a storage device having computer readable program code stored therewith, the computer readable program code comprising:
computer readable program code configured to operate an audio receiver and a memory of an information handling device to store audio;
computer readable program code configured to receive input activating a virtual assistant of the information handling device; and
computer readable program code configured to, after activation of the virtual assistant, process the audio stored to identify one or more actionable items for the virtual assistant.
